(19) United States
(12) Patent Application Publication
(10) Pub. No.: US 2002/0002891 A1
(43) Pub. Date: Jan. 10, 2002

(54) Corner alignment device for punching sheet materials

(76) Inventor: Robert Arnold, Spokane, WA (US)

Correspondence Address: SOFER & HAROUN, L.L.P., Suite 1921, 342 Madison Avenue, New York, NY, 10173, US

(21) Appl. No.: 09/820,177

(22) Filed: Mar. 28, 2001

Related U.S. Application Data
(60) Provisional application No. 60/215,893, filed on Jul. 5, 2000.

(51) Int. Cl. B26F 1/14

(52) U.S. Cl. 83/619; 83/620; 83/683; 83/687

(57) ABSTRACT

An alignment device for aligning a punch tool to punch a design into a sheet media. The alignment device comprises a base platform having at least one sheet media receiving area. The base platform has at least one punch tool receiving area with at least one punch tool mount disposed therein. The punch tool mount is configured to removably secure the punch tool, and a portion of the punch tool mount protrudes into the sheet media receiving area. The device also comprises first and second guide edges disposed angularly from at least one of the punch tool mounts. The first guide edge disposed on one side of the punch tool mount. The second guide edge disposed on an opposite side of the punch tool mount. When the punch tool is secured in the punch tool mount with the punch tool protruding into the sheet media receiving area and when the sheet media is placed in the sheet media receiving area and along the first and second guide edges, the punch tool is positioned to punch the design into the sheet media.

This application claims the benefit of priority from Applicant's co-pending U.S. Provisional Application Ser. No. 60/215,893 filed on Jul. 7, 2000 entitled “CORNER ALIGNMENT DEVICE FOR PUNCHING SHEET MATERIALS”, which is incorporated by reference herein.

### Field Of The Invention

This invention relates to an alignment device. More specifically, this invention relates to an alignment device for use with punching a sheet media with a punch tool.

### BACKGROUND OF THE INVENTION

This invention relates to the use of manually operated punch tools such as those commonly referred to as “craft punches,” or “corner punches” or “corner rounders” to produce decorative or function holes or edge shapes in the corners of sheet media such as paper or card stock. These punches typically comprise a metal die with a spring loaded metal punch and housing, typically fabricated with plastic, and may include internal guides for the corners of the media being punched.

In the prior art it is necessary to align the corners of the media being punched with the small guides internally disposed within the punch assembly, if so equipped. The guiding edges of the internal guides are not easily visible to the user during use, and it is difficult and time consuming to align the media accurately to the internal guides. Even when the media is carefully aligned, misjudging the material position or movement while punching often occurs resulting in poorly aligned holes or edge shapes. Some punches do not include guides, and they are even more difficult to align accurately. As such, it is the aim of the present invention to overcome these difficulties and provide a means for accurately aligning the media to be punched within the punching slot of the punch tool so as to produce accurately aligned comer punches.

### SUMMARY OF THE INVENTION

In one embodiment of the present invention, an alignment device is provided for aligning a punch tool to punch a design into a sheet media. The alignment device is comprised of a base platform with at least one sheet media receiving area. The base platform has at least one punch tool receiving area with at least one punch tool mount positioned therein, with the punch tool mount configured to removably secure the punch tool where a portion of the punch tool mount protrudes into the sheet media receiving area.

The alignment device also comprises first and second guide edges disposed angularly from the punch tool mount with the first guide edge disposed on one side of the punch tool mount and the second guide edge disposed on an opposite side of the punch tool mount, such that when the punch tool is secured in the punch tool mount with the punch tool protruding into the sheet media receiving area and when the sheet media is placed in the sheet media receiving area and along the first and second guide edges, the punch tool is positioned to punch the design into the sheet media.

In another embodiment of the present invention the first and second guide edges define a raised wall relative to the base platform.

In another embodiment of the present invention the punch tool receiving area further comprises a second punch tool mount elevated relative to the first punch tool mount; the punch tool receiving area further comprises a third punch tool mount elevated relative to the second punch tool mount; and the punch tool receiving area further comprises a fourth punch tool mount elevated relative to the third punch tool mount. In this configuration, the punch tool receiving area has a first, second, third and fourth, punch tool mounts disposed therein.

In another embodiment of the present invention, each one of the punch tool mounts support one or more of a plurality of punch tools.

In another embodiment of the present invention the base platform has at least one of the punch tool mounts disposed in a comer of the base platform. The base platform can also have at least one the punch tool mount disposed in each one of four corners of the base platform where at least two of the punch tool mounts share a common sheet media receiving area located in the center of the base platform.

In another embodiment of the present invention the base platform has at least one punch tool mount disposed along a side edge of the base platform. The base platform can also have at least one of the punch tool mounts disposed along each of four side edges where the punch tool mounts have separate sheet media receiving areas.

In another embodiment of the present invention, the first and second guide edges that extend away from the punch tool mount are disposed at a 90 degree angle with respect to one another. Additionally, the device maintains first and second sets of guide lines disposed on the surface of the base platform in one of the sheet media receiving areas, wherein the first and second set of guidelines run substantially parallel to corresponding guide edges such that a user can vary the positioning of the sheet media with respect to the punch tool.

In another embodiment of the present invention, the base platform further comprises an upper surface comprised of a hard durable surface suitable for craft uses and a lower surface comprised of a non-slip material for use in gripping a working surface during use.

In another embodiment of the present invention the device further comprises a punch cavity disposed within the punch tool receiving area and configured to allow the punch shaft of the punch tool to depress below the surface of the base platform and also to allow refuse from the sheet media to fall through the base platform so as not to hinder operation of the device.

In another embodiment of the present invention a leverage device is provided comprised of a base, an extension arm, a leverage arm button extension and a handle, where the leverage device is configured to provide a user with additional leverage for design punching when using multiple or thicker sheet media.

In another embodiment of the present invention, the punch tool mounts are marked with a letter code which corresponds to the design of a punch tool base, so as to provide an easy method of identifying which of the punch tools will work in the punch tool mounts disposed on said platform.

### BRIEF DESCRIPTION OF THE DRAWINGS

FIG. 1 is a perspective view of the alignment device, in accordance with one embodiment of the present invention;

FIG. 1A is a plan view of the alignment device, in accordance with one embodiment of the present invention;

FIG. 2A is a plan view of several punch tools each disposed in a singularly defined punch tool mount, in accordance with one embodiment of the present invention;

FIG. 2B is close up view of a punch tool receiving area, in accordance with one embodiment of the present invention;

FIG. 3 is an elevation view of a punch tool, in accordance with one embodiment of the present invention;

FIG. 4 is a plan view of an alignment device and a chart, in accordance with one embodiment of the present invention;

FIG. 5 is a close up view of a punch tool receiving area with guide edges and guide lines, in accordance with one embodiment of the present invention;

FIGS. 6A and 6B are views of an alignment device in use with a leverage device, in accordance with one embodiment of the present invention;

FIG. 7 is a flow chart of the steps used in operating an alignment device, in accordance with one embodiment of the present invention;

FIG. 8 is a plan view of the alignment device in use with a sheet media, in accordance with one embodiment of the present invention;

FIGS. 9a and 9b are close up plan views of the alignment device with an alternatively positioned punch tool in the same punch mount, in accordance with one embodiment of the present invention;

FIG. 10 is a plan view of the alignment device in use with a sheet media, in accordance with one embodiment of the present invention; and

FIG. 11 is a plan view of the alignment device in use with a sheet media, in accordance with one embodiment of the present invention.

### DETAILED DESCRIPTION

Structure of Device

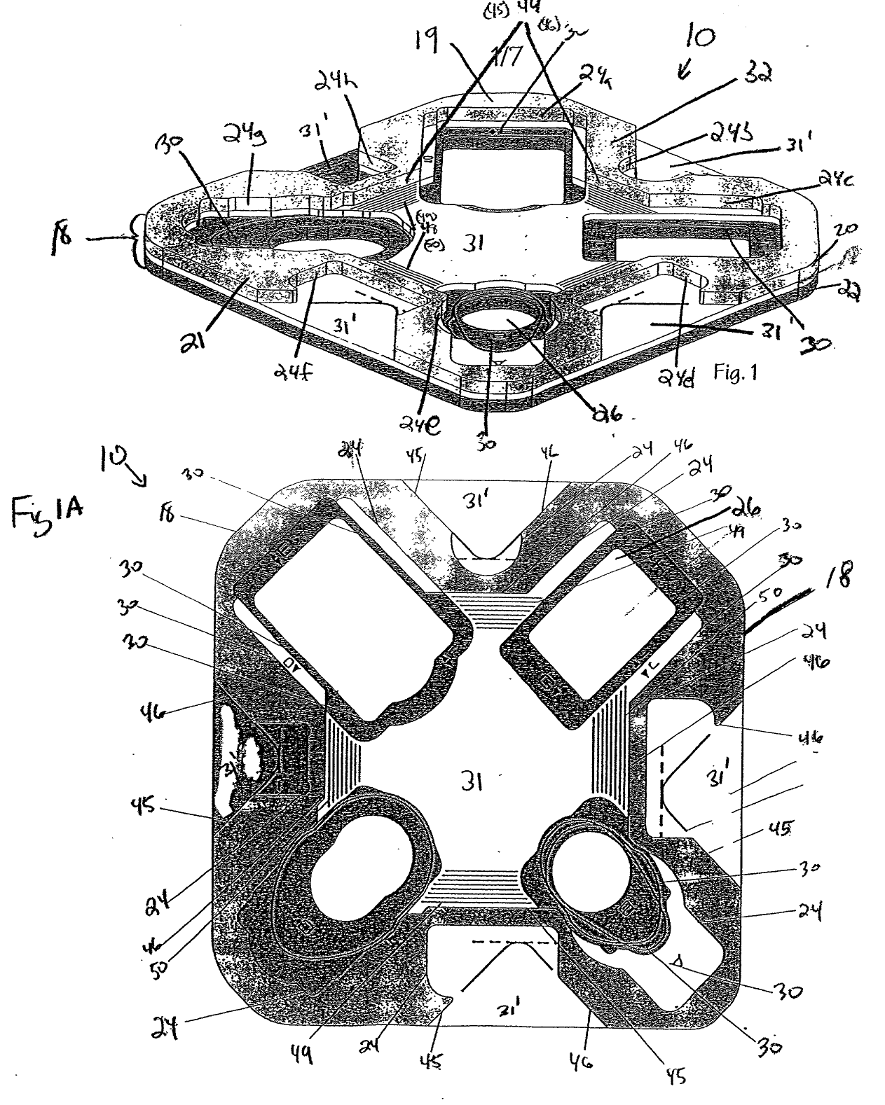

In one embodiment of the present invention and with reference to FIG. 1, an alignment device 10 is configured to provide a means for accurately aligning a sheet media 14 within a punch tool 12 so as to facilitate the use of punch tool 12 in punching a design 16 into sheet media 14.

To this end, as illustrated in FIG. 1, device 10 is made up of a base platform 18 preferably constructed of sturdy material such as hard polymer. Base platform 18 has an upper surface 20 and a lower surface 22. Lower surface 22 is preferably coated with a thin layer of a material which will removably grip a working surface and prevent device 10 from moving around during operation and cushion and protect the working surface from damage. Upper surface 20 is preferably a durable surface appropriate for general craft purposes such as a hard polymer, which allows for easy cleaning when device 10 is finished being used. It should be noted that the materials described herein for the construction base platform 18 and the materials used to cover lower surface 22 are intended only as examples of possible materials to be used however, any such material that can adequately support device 10 are within the contemplation of the present invention.

Base platform 18 is preferably substantially square in shape having comer regions 19 and side edges 21. This is the shape of base platform 18 that will be used to illustrate the salient features of the present invention, however, it should be noted that this square shape is intended only as an example and any shape for base platform 18 that is useful in the construction of device 10 is within the contemplation of the present invention. For example, base platform 18 can be formed in a substantially hexagonal or octagonal formation in order to provide more comer regions to accommodate a wider variety of punch tools 12.

Located on base platform 18, punch tool receiving areas 24a-24h are each configured to support any number of punch tools 12. Each punch tool receiving area 24 is provided with at least one punch cavity 26 that allows for the punch shaft 28 of punch tool 12 to depress below the surface of a punch mount 30 of base platform 18 as is required by some of punch tools 12 used with device 10. Punch mount 30 is discussed in more detail below. Also, punch cavity 26 allows for refuse from the punched sheet media 14 to fall to the working surface so that device 10 can be used many times without having to continuously clean out punch tool receiving area 24.

Punch tool receiving areas 24 are preferably located on the periphery of base platform 18 in comer regions 19 and along side edges 21. A raised wall 32 which is disposed on the top of and around the periphery of base platform 18 in such a way as to substantially define the limits of punch tool receiving areas 24a-24h. As such, raised wall 32 is fashioned in such a way as to define punch tool receiving areas 24 by outlining a rear and two side edges leaving an open front side. The open front side of punch tool receiving area 24 is positioned so as to correspond to the media slot 38 in punch tool 12 that accepts sheet media 14.

As illustrated in FIG. 1 punch tool receiving areas 24 can be located either at comers 19 of base platform 18 or in the middle of edges 21 of base platform 18. Punch tool receiving areas 24a, 24c, 24e and 24g located at comers 19 of base platform 18 and are configured such that the open front side area faces in towards a central sheet media receiving area 31 located in the center of base platform 18. On the other hand, punch tool receiving areas 24b, 24d, 24f and 24h located in the middle of edges 21 of base platform 18 preferably are configured such that the open front side faces away from the center of the base platform towards a sheet media receiving area 31′, one for each punch tool receiving area 24. This configuration allows for more punch tool receiving areas 24 to be fit onto a single device 10.

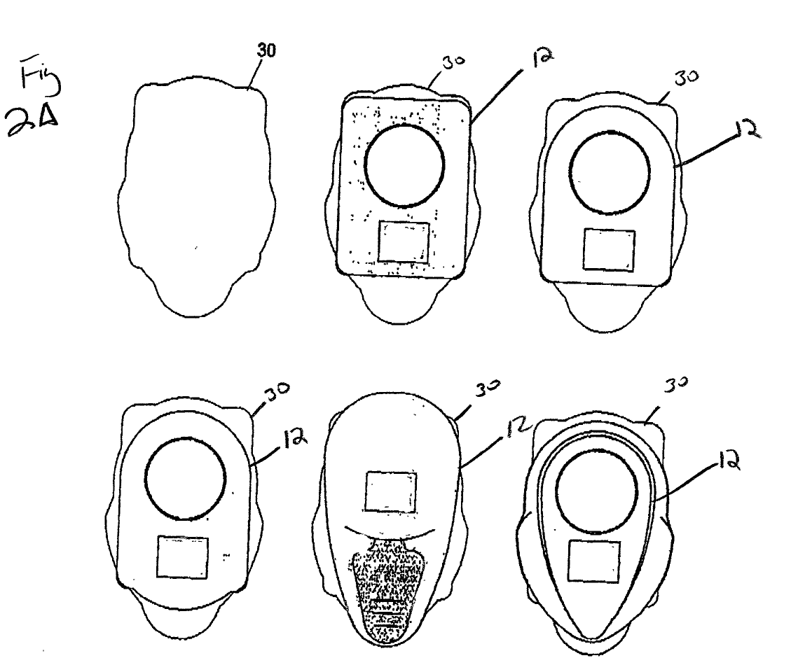

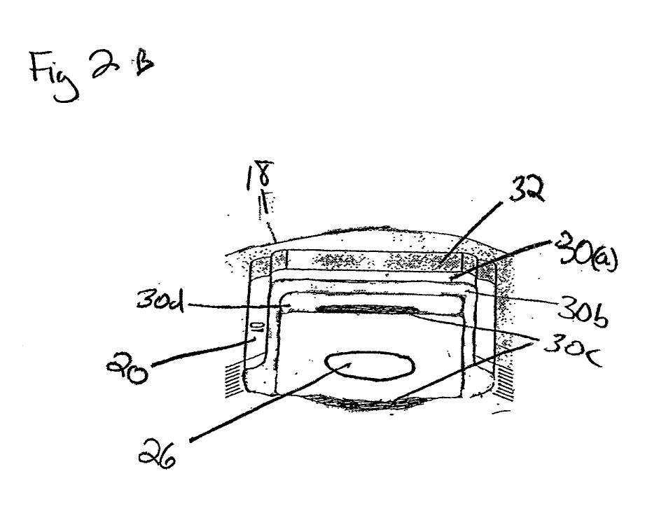

In one embodiment of the present invention, each punch tool receiving area 24a-24h has at least one punch tool mount 30 disposed therein. Punch tool mount 30 is formed by a recessed groove cut into upper surface 20 of base platform 18 in punch tool receiving area 24 or by a recessed groove cut into upper surface 20 of base platform 18 at some location along edges 21. Punch tool mount 30 is preferably shaped in accordance with a base 36 of one or more of a particular kind of punch tool 12 such that when punch tool 12 is placed in punch tool mount 30 it will be held firmly in place during operation of device 10. It should be noted that any one punch tool mount 30 may provide a fit for multiple bases 36 of punch tools 12. For example, FIG. 2A depicts 5 separate punch tools 12 that have bases 36 that all fit into a single punch tool mount 30.

In an alternative design, punch tool mount 30 can be elevated above upper surface 20 of base platform 18 such that punch tool mount 30 is located in raised position relative to base platform 18. However, for the purposes of illustration of the salient features of the present invention, the punch tool mounts 30 are configured as grooves cut into upper surface 20 of base platform 18, however it should be noted that this is in no way intended to limit the scope of the present invention, and any configuration of punch tool mounts 30 which can adequately support punch tool 12 during operation is within the contemplation of the present invention.

Punch tool mount 30 is preferably of a depth between 1/32″ and ⅛″ or deep enough to restrain punch tool 12 so that it does not inadvertently move during operation. However, any depth for punch tool recess that properly holds punch tool 12 in place during operation is within the contemplation of the present invention.

Each punch tool receiving area 24a-24h contains at least one punch tool mount 30, however it is possible using a multiple punch tool mount 30 layering to allow for more than one punch tool mount 30 to be cut into one punch tool receiving area 24. Any number of punch tool mounts 30 can be located in a given punch tool slot 24, so long as it does not interfere with the effectiveness of any other punch tool mount 30. To this end punch tool receiving areas 24 each maintain any number of punch tool mounts 30.

For example, as illustrated in FIG. 2B, punch tool receiving area 24a maintains four punch tool mounts 30(a), 30(b), 30(c), and 30(d). Punch tool mount 30(d) corresponding to the punch tool with the smallest punch tool base 36 is located farthest from upper surface 20 of base platform 18. Located at an elevated position from punch tool mount 30(d), punch tool mount 30(c) is located above punch tool mount 30(d) and closer to upper surface 20 of base platform 18, and configured to support a punch tool 12 having a base 36 slightly larger than that of the punch tool associated with punch tool mount 30(d).

Located at an elevated position from punch tool mount 30(c), punch tool mount 30(b) is located above punch tool mount 30(c) and closer to upper surface 20 of base platform 18, and configured to support a punch tool 12 having a base 36 slightly larger than that of the punch tool associated with punch tool mount 30(d). Lastly punch tool mount 30(a) is located closest to upper surface 20 of base platform 18 and is configured to support a punch tool 12 having the largest base 36 for use in that particular punch tool receiving area 24a.

It should be noted that this configuration is only intended to illustrate one sample configuration of the punch tool mounts 30 within a punch tool receiving area 24 and is no way intended to limit the scope of the present invention. For example, in the case of irregular shaped punch tools 12 it is possible that a larger punch tool mount 30 may be located farther from upper surface 20 than a smaller punch tool mount 30. Any configuration of multiple punch tool mounts 30 within a single punch tool receiving area 24 that allows for the independent function of each punch tool mount 30 is within the contemplation of the present invention.

Multiple punch tool mounts 30 in a single punch tool receiving area 24 is not to be confused with multiple punch tools 12 used in a single punch tool mount. As described above, because in some cases base 36 of punch tools 12 do not vary significantly, a single punch tool mount 30 may accommodate several different punch tools 12. As such it is within the contemplation of the present invention that a single punch tool receiving area 24 may have several punch tool mounts 30 disposed therein, each one of which is capable of accommodating several punch tools 12.

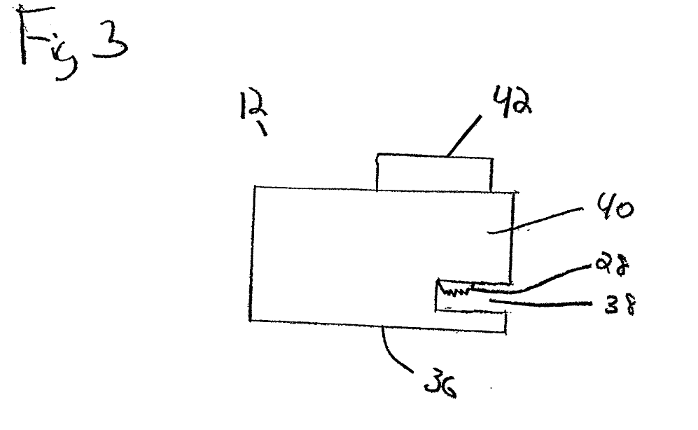

As illustrated in FIG. 3 punch tool 12 is of design comprised of punch tool base 36, media slot 38, a main body portion 40, and punch button 42. Punch tool 12 is configured such that when sheet media 14 is placed within media slot 38 in between punch tool base 36 and main body portion 40, and punch button 42 is depressed, design 16 is punched into sheet media 14.

To this end, punch tool mounts 30 are designed to match the shape of base 36 of a particular punch tool 12 and to be of depth such that when a punch tool 12 is inserted into punch tool mount 30, upper surface 20 of platform 18 will be approximately even with or lower than the upper surface of punch tool base 36 allowing sheet media 14 to slide evenly into media slot

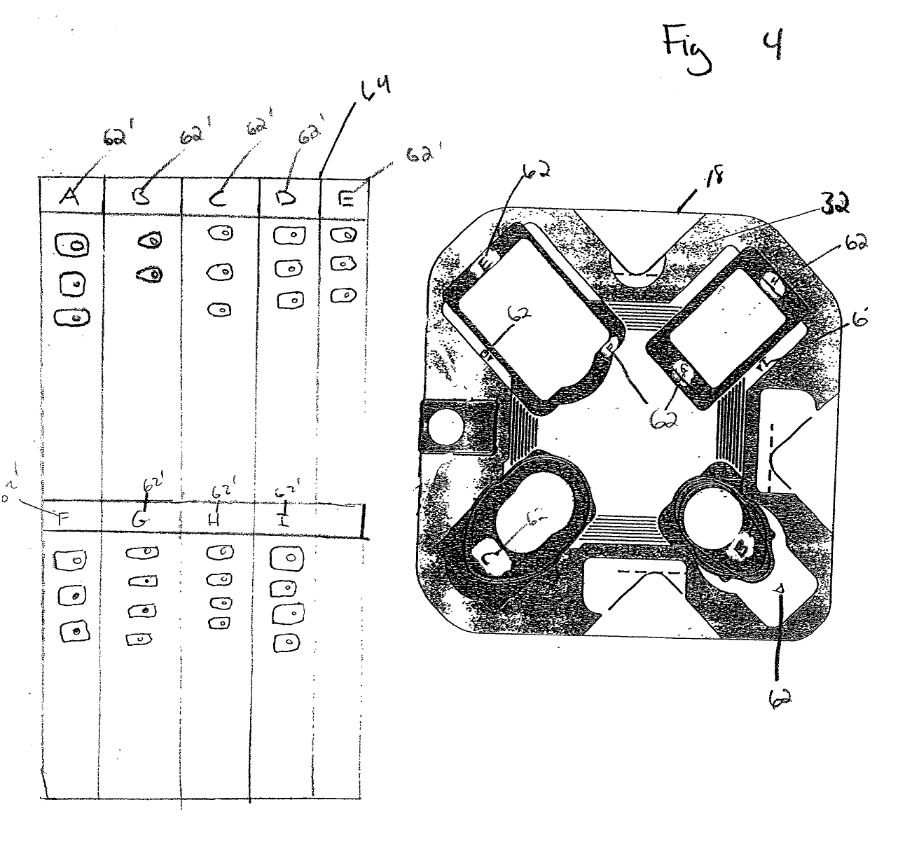

In one embodiment of the present invention, as illustrated in FIG. 4, letter codes 62 can be placed on the varying layers of in a punch tool receiving area 24, identifying each separate punch tool mount 30. To this end, punch tool chart 64 is provided to a user which identifies some or all of the punch tools 12 available, that can be accommodated by each of the punch tool mounts disposed on device 10. Punch tool chart 64 identifies and groups some or all of the punch tools 12 which can be used on device 10 and groups them according to the shape of their base 36, which is the principle element of a punch tool 12 which determines if it can be used in a particular punch tool mount 30. As such, a user in possession of a punch tool 12, using chart 64 can identify which punch tool mount 30 is appropriate for the desired punch tool 12, provided that particular punch tool 12 is displayed. It should be noted that the organization of punch tools on chart 64 can be based on any number of criteria including but not limited to size, the associated punch tool mounts 30, thickness of base 36 or manufacturer of punch tool 12, so long as chart 64 ultimately assists the user in selecting the correct punch tool mount 30 for a particular punch tool 12.

It should be noted that if a particular punch tool 12 is not shown on chart 64 it does not mean that it will not work in device 10, chart 10 is simply a listing of all of the known punch tools 12 that work with device 10, however it is possible that punch tools 12 not listed will fit into one ore more of the punch tool mounts 30.

Chart 64 and letter codes 62 are intended only as examples of a coding system used to mach punch tool mounts 30 to bases 36 of punch tools 12. Any similar system used for matching punch tools 12 to punch tool mounts 30 for use with device 10 are within the contemplation of the present invention. It should be noted that although chart 64 and letter codes 62 provide a useful feature to device 10 they are not essential to its operation. Punch tool mounts 30 can be matched with any number of punch tools 12 by the user even in the event that chart 64 or letter codes 62 are not provided, they are included here only as an example of one method of simplifying the operation of device 10.

In one embodiment of the present invention, raised wall 32 provides device 10 with a guide edge pair 44, which extend angularly outward from the open front side of punch tool receiving areas 24 so as to provide a means for aligning sheet media 14 within punch tool 12. Guide edge pair 44 is comprised a first guide edge 45 located on one side of punch tool receiving area 24 and a second guide edge 46 located on an opposite side of punch tool receiving area 24. First and second guide edges 45 and 46 are preferably between ¼ inch and ¾ inches tall corresponding to the height of raised wall 32 of platform 18, however, first and second guide edges 45 and 46, formed by raised wall 32 can be any height which is sufficient to guide sheet media 14 into punch tool receiving area 24 and the corresponding punch tool 12 and yet not so high as to substantially interfere with sheet media 14 that extends beyond the oppositely positioned guide edges.

To illustrate the function of first and second guide edges 45 and 46, the guide edge pair 44 for one particular punch tool receiving area 24c has been used. However, it should be noted that any first guide edge 45 disposed on one side of punch tool receiving area 24 and a second guide edge 46 disposed on an opposite side of that same punch tool receiving area 24 so as to form a guide edge pair 44 is within the contemplation of the present invention. Moreover, the same configuration of first and second guide edges 45 and 46 holds for punch tool receiving areas 24b, 24d, 24f, and 24h located along edges 21 of base platform 18.

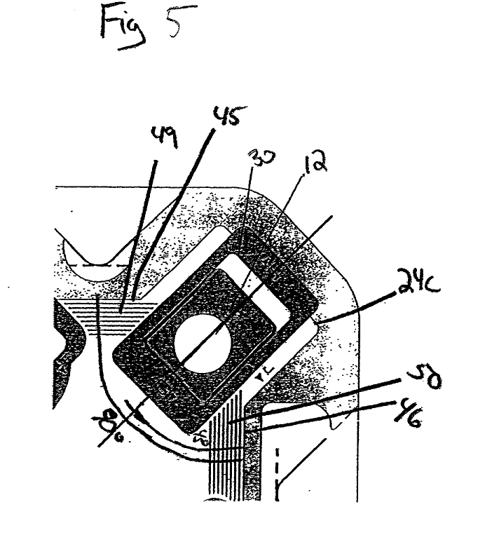

In a preferred configuration, as illustrated in FIGS. 1, 1a and 5, first and second guide edges 45 and 46 are positioned such that they extend away from punch tool receiving areas 24 extending from the open front edge at a 45 degree angle on each side. First guide edge 45 extends away from punch tool receiving area 24c at a 45 degree angle in one direction, and second guide edge 46 extends away from punch tool receiving area 24c in an opposite direction. This configuration creates a 90 degree angle between first and second guide edges 45 and 46 disposed on either side of punch tool receiving areas 24c, such that when sheet media 14 is butted against first and second guide edges 45 and 46, sheet media 14 is positioned within punch tool receiving area 24c at distance so as to place design 16 at the proper desired location on sheet media 14. Although first and second guide edges 45 and 46 are preferably disposed at 45 degree angles relative to punch tool receiving area 24c and at 90 degrees relative to each other, this configuration is intended only as an example of one possible configuration of first and second guide edges 45 and 46, however, any such angle other than 90 degrees that will align sheet media 14 properly, such as for use with non square or irregular shaped sheet media 14, is within the contemplation of the present invention. It should be noted that guide edges 45 and 46 for punch tool receiving areas 24b, 24d, 24f, 24h are formed by breaks in raised wall 32 such that sheet media receiving areas 31 ′ are formed, configured to provide first and second guide edges 45 and 46 to align sheet media 14 into punch tools 12.

In another embodiment of the present invention, as illustrated in FIG. 5, guide line pair 48 is provided on upper surface 20 of platform 18 comprised of first guide lines 49 and second guide lines 50. First and second guide lines 49 and 50 are consist of of parallel lines disposed in front of first and second guide edges 45 and 46 respectively, as defined by a distance farther from the corresponding punch tool receiving area 24, so as to add versatility to each of punch tool receiving areas 24. First and second guide edges 45 and 46 are fixed in place because they are formed from the immobile raised wall 32, thus first and second guide lines 49 and 50 create additional guide markers to manipulate the positioning of sheet media 14 within punch tool 12 so as to allow the user more freedom to alter the location of corner design 16 and its proximity to the edge of sheet media 14. A more detailed description of the operation of first and second guide lines 49 and 50 will follow in the operation discussion.

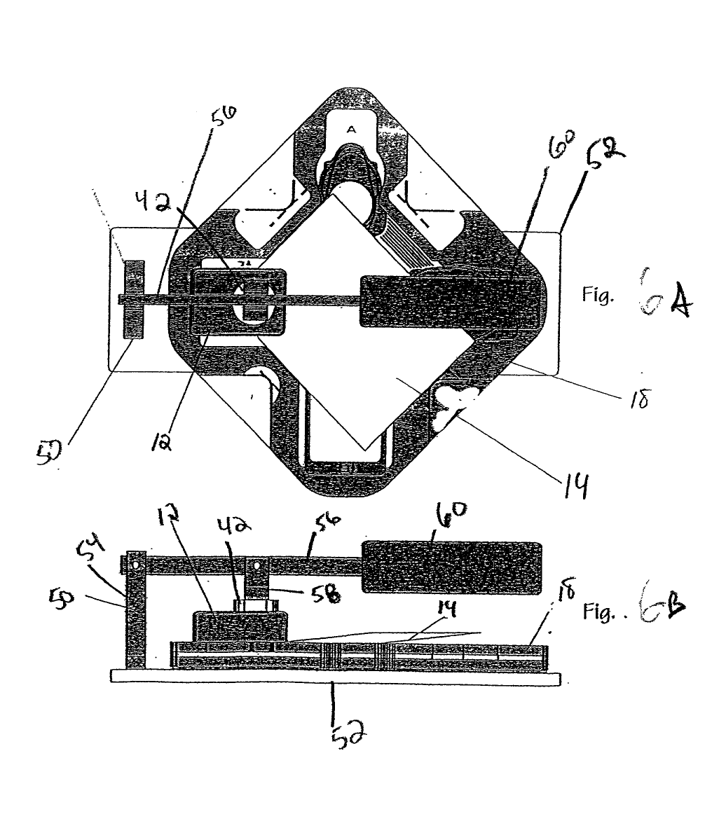

In another embodiment of the present invention, a leverage device 51 can be added to alignment device 10 so as to provide additional leverage for the user in order to punch multiple sheet media 14 or thicker sheet media 14. As illustrated in FIGS. 6A and 6B, leverage device 51 is comprised of a base 52, extension arm 54, a lever arm 56 a button extension 58 and a handle 60. In operation, device 10 is placed on base 52 and positioned such that when punch tool 12 is in place button extension 58 falls squarely on punch button 42. Using the added leverage created by extension arm 54 and lever arm 56, a user gains added pressure to punch sheet media 14 when punching multiple sheet media 14 or when using thicker sheet media 14. Leverage device 51 does not alter the operation of device 10 or punch tool 12 but simply adds leverage making the use of device 10 easier for elderly or young individuals or when using thicker or multiple sheet media 14.

Operation of Device

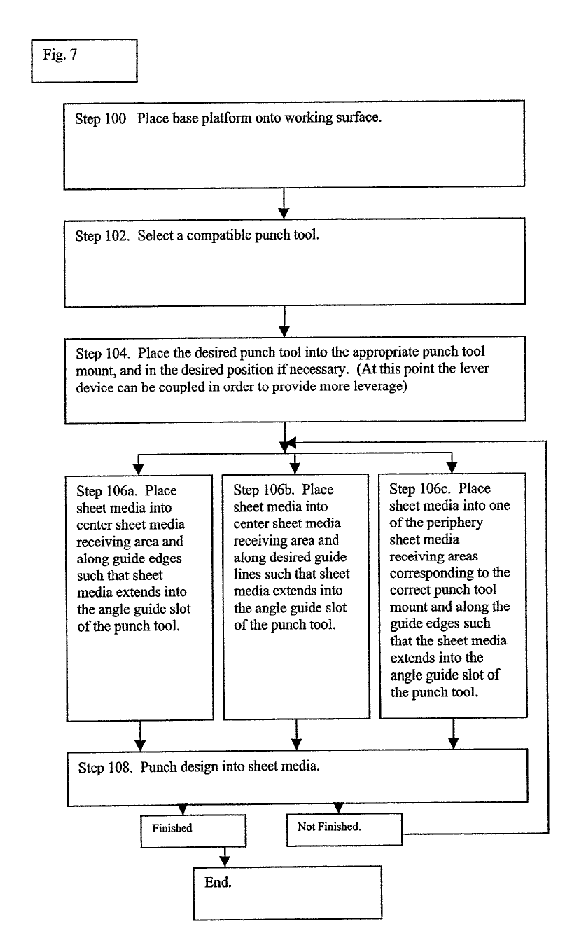

In one embodiment of the present invention, device 10 is configured to align punch tool 12 with sheet media 14 to stamp design 16 into sheet media 14. To this end, and as illustrated in FIG. 7, a user begins at step 100, by placing platform 18 onto a surface whereby lower surface 22 can be frictionally positioned on a work surface so as not to move or slide about during operation.

Next, at step 102, the user selects a punch tool 12 from any number of punch tools 12 corresponding to the desired design 16 to be used. The only limitation in choosing punch tool 12 is that punch tool base 36 must be compatible with at least one punch tool mount 30 in one punch tool receiving area 24. This compatibility can be a result of device 10 being specifically designed for use with a particular manufacturer's punch tools 12, or alternatively, this compatibility can be a result of the generic design for punch tool mounts 30 such that a variety of mounts 30 are disposed on platform 18 of device 10 in various shapes, sizes and depths corresponding to the more common designs for punch tools 12. The size of punch tool receiving area 24 is not a limiting factor in a user's choice for punch tools 12 because raised wall 32 which defines the punch tool receiving areas 24 are at least as accommodating as to punch tools 12 as the largest punch tool mount 30 found therein.

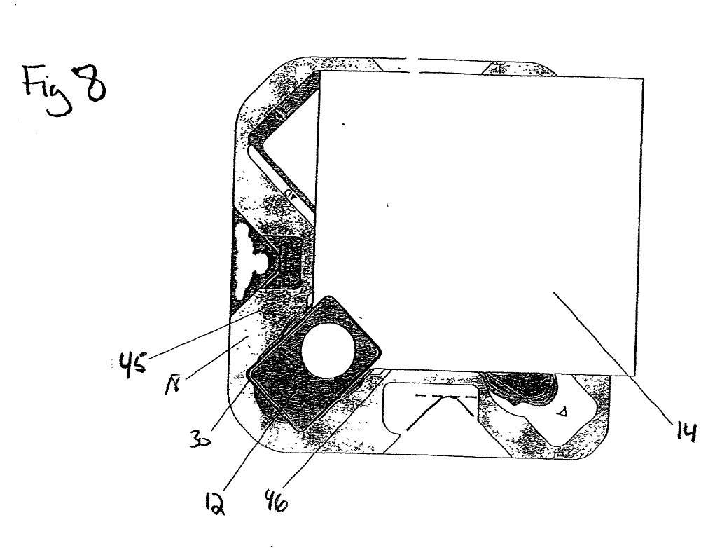

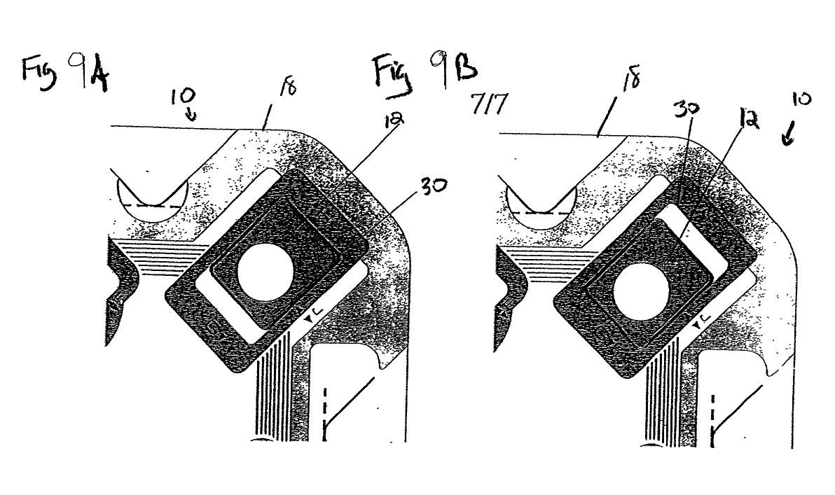

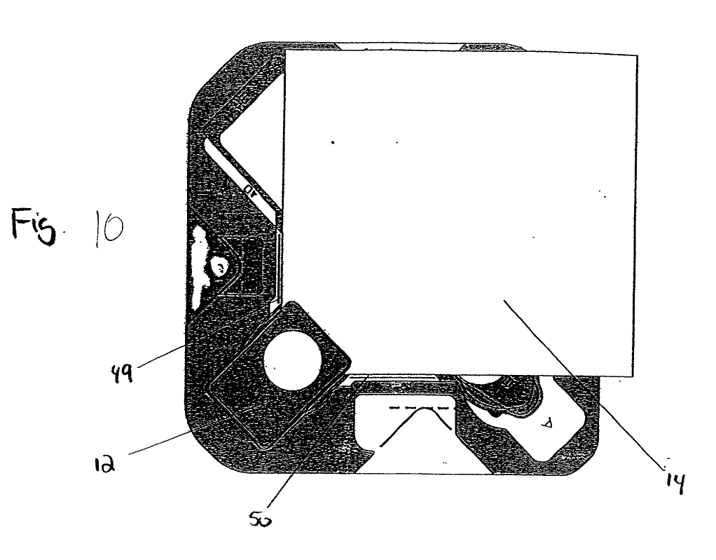

Next, at step 104, as illustrated in FIG. 8 the user places the desired punch tool 12 into the corresponding punch tool mount 30 found in the appropriate punch tool receiving area 24. Two separate possibilities arise at this time, the first is where punch tool 12 fits exactly into punch tool mount 30. In this case the user simply proceeds to the next step. However, as illustrated in FIGS. 9a and 9b, in some cases, particularly where punch tool base 36 is rectangular, they may be some allowance for the user to adjust the position of punch tool 12 within the confines of punch tool mount 30 such that the final position of design 16 can be adjusted to and away from the corner or edge of sheet media 14 by sliding punch tool 12 closer or farther away from the center of platform 18. In the latter case, the user must first decide on either the forward position or the setback position before continuing on to the next step. It should be noted at this time if the user intends to use leverage device 51 it should be placed under platform 18 and in contact with push button 42 of punch tool 12.

Proceeding on to step 106a, after the user sets punch tool 12 into the proper position, the user then places sheet media 14 onto device 10 as illustrated in FIG. 7. Sheet media 14 is placed so that the desired corner or edge is positioned between punch tool base 36 and punch tool body 40 within media slot 38. The edges of sheet media 14 extending away from the desired corner or edge to be punched are aligned against first and second guide edges 45 and 46 which extend away from punch tool receiving area 24. When sheet media 14 is in place with both edges firmly abutted against the corresponding first and second guide edges 45 and 46, sheet media 14 is automatically positioned such that when punched, design 16 is punched accurately.

In one illustrative embodiment of the present invention the intended location of design 16 is located substantially equidistant from either edge extending from the desired corner and approximately between ⅛″ and ½″ away from the desired corner point. However, device 10 can be used punch design 16 onto any number of location on sheet media 14. Therefore, any use of device 10 and the salient features thereof to place design 16 onto sheet media 14 more accurately and consistently is within the contemplation of the present invention.

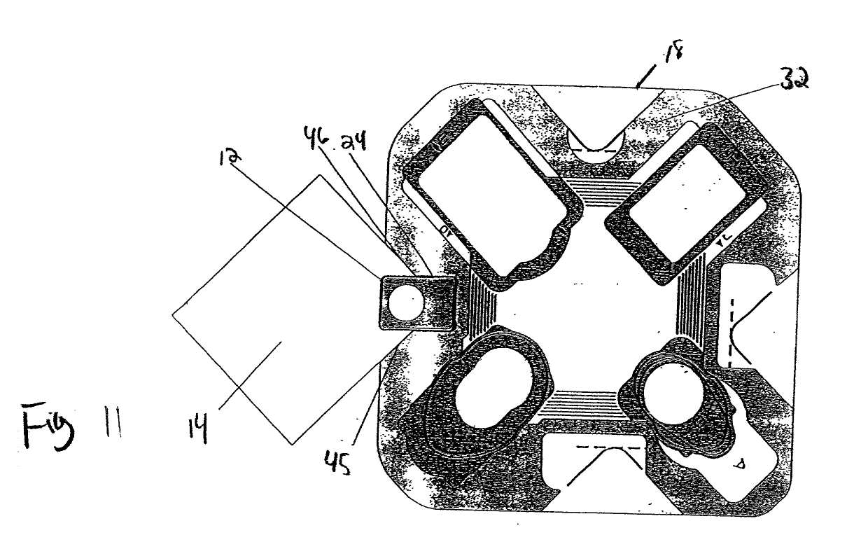

Alternatively, at step 106b, as illustrated in FIG. 10, the user then places sheet media 14 onto device 10. Sheet media 14 is placed so that sheet media 14 is positioned between punch tool base 36 and punch tool body 40 within media slot 38. The edges of sheet media 14 are aligned against first and second guide lines 49 and 50 which extend away from punch tool receiving area 24, positioned substantially parallel to first and second guide edges 45 and 46 respectively. When sheet media 14 is in place with both edges firmly held along the corresponding first and second guide lines 49 and 50, sheet media 14 is positioned such that when punched, design 16 is punched accurately

In one illustrative embodiment of the present invention, the intended location of design 16 is located substantially equidistant from either edge extending from the desired corner and approximately between ⅛″ and ½″ away from the desired corner point. Unlike step 106a, step 106b allows for more user versatility, particularly with punch tools 12 that fit snugly into punch tool recess 30. However, device 10 can be used punch design 16 onto any number of location on sheet media 14. Therefore, any use of device 10 and the salient features thereof to place design 16 onto sheet media 14 more accurately and consistently is within the contemplation of the present invention.

Alternatively, at step 106c, as illustrated in FIG. 11, sheet media 14 onto device 10. Sheet media 14 is placed so that it is positioned between punch tool base 36 and punch tool body 40 within media slot 38. The edges of sheet media 14 are aligned against first and second guide edges 45 and 46, which extend away from punch tool receiving area 24 and away from the center of platform 18. When sheet media 14 is in place with both edges firmly abutted against corresponding first and second guide edges 45 and 46, sheet media 14 is automatically positioned such that when punched, design 16 will be properly positioned relative to the corner of sheet media 14 in accordance with design 16 of punch tool 12.

Next at step 108, while holding sheet media 14 in place, the user depresses punch button 42 thereby punching design 16 into sheet media 14. A user can then repeat steps 106-108 until all of the desired corners of sheet media 14 are marked with corner design 16.

This invention presents advantages over the prior art by securely holding punch tools 12 in place within punch tool mounts 30 during operation. Additionally, by adding external guides, namely first and second guide edges 45 and 46 and first and second guide lines 49 and 50, a user can position sheet media 14 more swiftly and also attain more accurate and consistently placed designs 16 than are attainable using the methods and devices found in the prior art.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

what is claimed is:

1. An alignment device for aligning a punch tool to punch a design into a sheet media, said alignment device comprising:
a base platform having at least one sheet media receiving area;
said base platform having at least one punch tool receiving area with at least one punch tool mount disposed therein, said punch tool mount configured to removably secure the punch tool, a portion of said punch tool mount protruding into said sheet media receiving area; and
first and second guide edges disposed angularly from at least one said punch tool mount, with said first guide edge disposed on one side of said punch tool mount, and said second guide edge disposed on an opposite side of said punch tool mount, such that when the punch tool is secured in said punch tool mount with the punch tool protruding into said sheet media receiving area and when the sheet media is placed in said sheet media receiving area and along said first and second guide edges, the punch tool is positioned to punch the design into the sheet media.

2. An alignment device as claimed in claim 1, wherein said first and second guide edges define a raised wall relative to said base platform.

3. An alignment device as claimed in claim 1, wherein said punch tool receiving area further comprises a second punch tool mount elevated relative to said first punch tool mount.

4. An alignment device as claimed in claim 3, wherein said punch tool receiving area further comprises a third punch tool mount elevated relative to said second punch tool mount.

5. An alignment device as claimed in claim 4, wherein said punch tool receiving area further comprises a fourth punch tool mount elevated relative to said third punch tool mount.

6. An alignment device as claimed in claim 1, wherein said punch tool receiving area has first, second, third and fourth, punch tool mounts disposed therein.

7. An alignment device as claimed in claim 1, wherein each one of said punch tool mounts support one or more of a plurality of said punch tools.

8. An alignment device as claimed in claim 1, wherein said base platform has at least one of said punch tool mounts disposed in a corner of said base platform.

9. An alignment device as claimed in claim 8, wherein said base platform has at least one of said punch tool mounts disposed in each one of four corners.

10. An alignment device as claimed in claim 9, wherein at least two of said punch tool mounts share a common sheet media receiving area located in the center of said base platform.

11. An alignment device as claimed in claim 1, wherein said base platform has at least one punch tool mount disposed along a side edge of said base platform.

12. An alignment device as claimed in claim 11, wherein said base platform has at least one said punch tool mount disposed along each of four side edges.

13. An alignment device as claimed in claim 12, wherein each said punch tool mount has a separate sheet media receiving area.

14. An alignment device as claimed in claim 1, wherein said first and second guide edges that extend away from said punch tool mount are disposed at a 90 degree angle with respect to one another.

15. An alignment device as claimed in claim 1, further comprising a first and second sets of guide lines disposed on the surface of said base platform in one of said sheet media receiving areas, wherein said first and second set of guidelines run substantially parallel to corresponding said guide edges such that a user can vary the positioning of the sheet media with respect to the punch tool.

16. An alignment device as claimed in claim 1, wherein said base platform further comprises an upper surface comprised of a hard durable surface suitable for craft uses.

17. An alignment device as claimed in claim 1, wherein said base platform further comprises a lower surface comprised of a non-slip material for use in gripping a working surface during use.

18. An alignment device as claimed in claim 1, further comprising a punch cavity disposed within said punch tool receiving area and configured to allow the punch shaft of the punch tool to depress below the surface of said base platform and also to allow refuse from the sheet media to fall through said base platform so as not to hinder operation of the device.

19. An alignment device as claimed in claim 1, further comprising a leverage device, said leverage device comprising a base, an extension arm, a leverage arm button extension and a handle, wherein said leverage device is configured to provide a user with additional leverage for design punching when using multiple or thicker sheet media.

20. An alignment device as claimed in claim 1, wherein at least one of said punch tool mounts is marked with a letter code which corresponds to the design of a punch tool base, so as to provide an easy method of identifying which said punch tools will work in any one of said punch tool mounts disposed on said platform.
